(19) United States
(12) Patent Application Publication
(10) Pub. No.: US 2010/0061010 A1
(43) Pub. Date: Mar. 11, 2010

(54) PARTICLE DIVERTER FOR HARD DISC DRIVE

(75) Inventors: Yimin Niu, Eden Prairie, MN (US); Ning Yu, Eden Prairie, MN (US); Robert John Bloom-Duren, Burnsville, MN (US); Srinivas Tadepalli, Eden Prairie, MN (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/204,895

(22) Filed: Sep. 5, 2008

(51) Int. Cl. G11B 33/14

(52) U.S. Cl. 360/97.02; G9B/33.035

(57) ABSTRACT

Bases for data storage systems are disclosed. Some embodiments of the bases are used in hard disc drives. Some embodiments include particle diverters. Certain embodiments of the particle diverters include a particle diverter opening adjacent to an actuator region of a hard disc drive.

### BACKGROUND

Hard disc drives commonly include a rigid housing having a base and a top cover that enclose a variety of components. The components include a medium or media for storage of digital information that is mounted on a motor assembly. The components also include an actuator assembly used to position one or more transducers along the medium to read and/or write information to particular locations on the medium. The transducers are mounted to a suspension of the actuator assembly. The suspension maintains the transducers adjacent to or in contact with the data surface of the medium. A voice coil motor is used to precisely position the actuator assembly.

Hard disc drives are sensitive to particulate contamination. Particles frequently enter hard disc drives during the manufacturing process or are generated by components within the disc drives. These particles can damage disc drive components and can negatively impact reliability. For example, particles in a disc drive can come into contact with the data surface of the medium. This impact can cause physical damage to the surface resulting in the data stored in the impact area being lost.

### SUMMARY

Bases for data storage systems are provided. Some embodiments of the bases are used in hard disc drives. Some embodiments include particle diverters. Certain embodiments of particle diverters include a particle diverter opening adjacent to an actuator region of a hard disc drive.

### BRIEF DESCRIPTION OF THE DRAWINGS

FIG. 1 is a simplified schematic diagram of a hard disc drive.

FIG. 2 is a top perspective view of a hard disc drive base.

FIG. 3 is a top view of a hard disc drive base that has a particle diverter with a particle trap cavity.

FIG. 4 is an enlarged top perspective view of the particle diverter with a particle trap cavity.

FIG. 5 is a top view of a hard disc drive base that has a particle diverter with a particle trap hole.

FIG. 6 is an enlarged top perspective view of the particle diverter with a particle trap hole.

### DETAILED DESCRIPTION

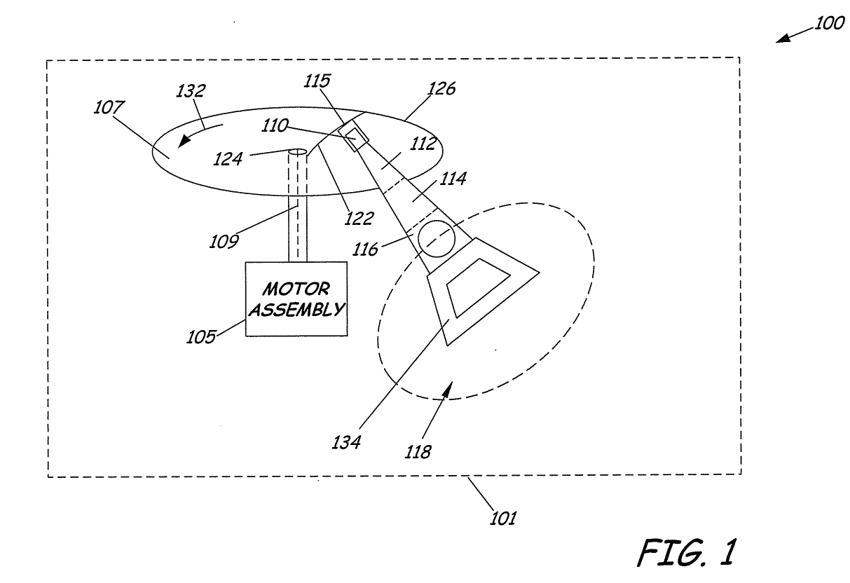

FIG. 1 is a simplified schematic diagram of a hard disc drive 100 in which embodiments of the present disclosure are useful. Hard disc drives are a common type of data storage system. While embodiments of this disclosure are described in terms of disc drives, other types of data storage systems should be considered within the scope of the present invention. Disc drive 100 includes an enclosure 101. Disc drive 100 further includes a disc or medium 107. Those skilled in the art will recognize that disc drive 100 can contain a single disc, as illustrated in FIG. 1, or multiple discs. As illustrated in FIG. 1, medium 107 is mounted on a motor assembly 105, such as a spindle motor assembly, which facilitates rotation of the medium about a central axis 109. Imaginary arrow 132 shows disc 107 being rotated in a counterclockwise fashion. Other embodiments of disc drive 100 have disc 107 rotating in a clockwise fashion. Each disc surface has an associated slider 110. Each slider 110 carries a read/write head 115 for communication with the surface of the disc.

Each slider 110 is supported by a suspension 112 which is in turn attached to a track accessing arm 114 of an actuator mechanism 116. Actuator mechanism 116 is rotated about a shaft by a voice coil 134 of a voice coil motor 118. As voice coil motor 118 rotates actuator mechanism 116, slider 110 moves in an arcuate path 122 between a disc inner diameter 124 and a disc outer diameter 126.

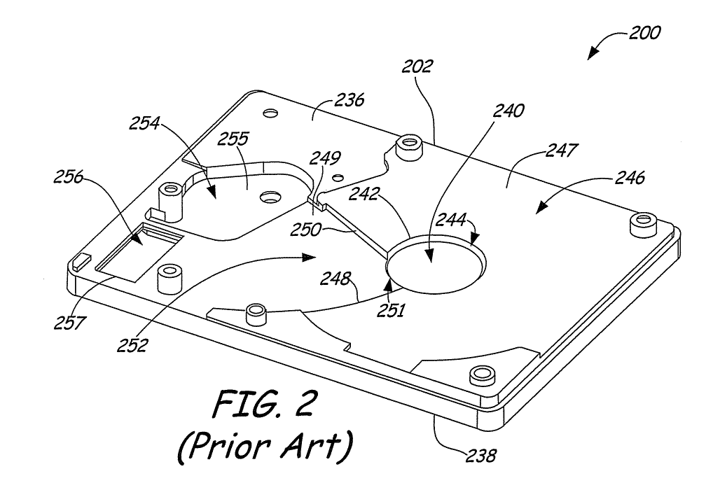

FIG. 2 is a top perspective view of a hard disc drive base 202 of a disc drive 200 with all internal components and side walls removed. Typically, an enclosure of a disc drive, such as enclosure 101 in FIG. 1, includes a base such as base 202 and a top cover. Base 202 includes an inner facing surface 236 and an outer facing surface 238. Base 202 also includes features for accommodating various internal components of a disc drive that, in the illustrated example, have been removed. Such accommodating features are integrally formed within base 202 by metal injection molding, stamping, machining, or other types of processes.

Base 202 includes a motor well 240. Motor well 240 is one example of an accommodating feature of base 202. Motor well 240 is integrally formed with base 202 and is configured to accommodate a motor assembly, such as motor assembly 105 illustrated in FIG. 1. In some embodiments, motor well 240 includes a motor well aperture 242. A medium region 246 is another example of an accommodating feature of base 202. Medium region 246 is integrally formed with base 202 and accommodates one or more media. Medium region 246 includes a medium region planar surface 247 that surrounds a portion 244 of motor well 240. Medium region 246 illustratively reduces airflow turbulence under the media or medium in the enclosure of the data storage system. Medium region 246 also includes a leading surface 248 and a trailing surface 250.

An actuator region 252 is another example of an accommodating feature of base 202. Actuator region 252 accommodates at least one track accessing arm of an actuator mechanism, such as track accessing arm 114 of actuator mechanism 116 illustrated in FIG. 1. As illustrated in FIG. 2, actuator region 252 includes an actuator region planar surface 249 which is recessed below medium region planar surface 247. Often, a track accessing arm requires space below the medium to rotate back and forth. Actuator region 252 provides such space and is defined by actuator region planar surface 249, leading surface 248, trailing surface 250, and a remaining portion 251 of motor well 240.

A voice coil motor region 254 is another example of an inner surface accommodating feature of base 202. Voice coil motor region 254 accommodates a voice coil motor, such as voice coil motor 118 illustrated in FIG. 1. As illustrated in FIG. 2, voice coil motor region 254 includes a voice coil motor region planar surface 255.

An electronic circuit region 256 is yet another example of an inner surface accommodating feature of base 202. Electronic circuit region 256 includes an electronic circuit aperture 257 that extends between inner facing surface 236 and outer facing surface 238 of base 202. Electronic circuit region 256 is configured to accommodate circuitry for transferring data from components internal to a data storage system to components external to the data storage system.

Embodiments of the present invention are illustrated by the following examples, but the particular shapes and sizes recited in these examples, as well as other conditions and details, should not be construed to unduly limit this disclosure.

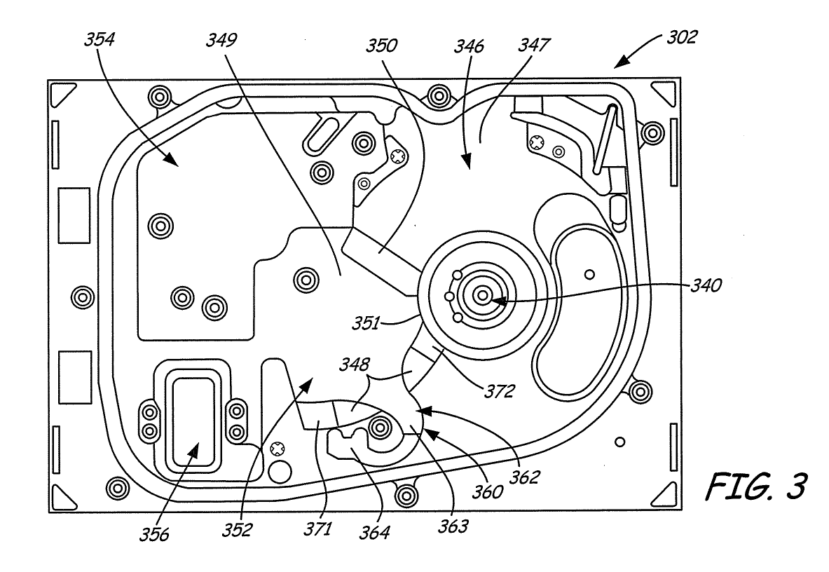

FIG. 3 is a top view of a hard disc drive base 302 that has a particle diverter 360 with a particle trap cavity 364. Like base 202 illustrated in FIG. 2, base 302 includes features for accommodating various internal components of a disc drive. Some of these features include: a motor well 340 that has an actuator region transition portion 351; a medium region 346 that has a planar surface 347; a leading surface 348 that has a first portion 371 and a second portion 372; a trailing surface 350; an actuator region 352 that has a planar surface 349 which is recessed below medium region planar surface 347; a voice coil motor region 354; and an electronic circuit region 356. In one embodiment, any or all of leading surface 348, trailing surface 350, and motor well transition portion 351 are sloped from the lower recessed planar surface 349 to the higher elevated medium region planar surface 347.

Base 302 also includes a particle diverter 360. Diverter 360 includes a canal 362 and a particle trap cavity 364. In one embodiment, not by limitation, canal 362 has a bottom surface 363 that is coplanar with actuator planar surface 349. Canal 362 is defined in part by a portion of actuator region 352, leading surface 348, medium region 346, and the entrance to cavity 364. In another embodiment, canal 362 is defined in part by a portion of the trailing surface 350 instead of a portion of the leading surface 348. In one embodiment, a canal opening is formed by the trailing surface comprising two portions and the canal extends from the trailing surface away from actuator region.

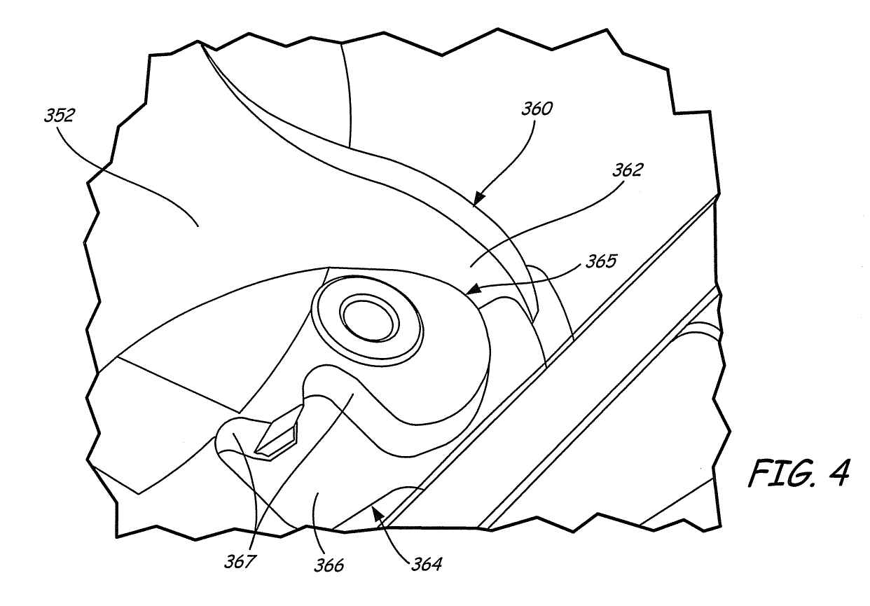

FIG. 4 is an enlarged top perspective view of particle diverter 360 with particle trap cavity 364. Cavity 364 has an opening 365 that is in fluid communication with particle diverter canal 362. Cavity 364 also has a bottom surface 366 and surrounding walls 367. In one embodiment, particle diverter canal 362 and cavity 364 are integrally formed with base 302, for example, by metal injection molding, stamping, machining, or other types of processes. In one embodiment, particle diverter 360 utilizes existing base 302 features. For example, base 302 may have an existing recessed cavity with surrounding walls that serves an existing function (e.g., provides clearance to accommodate an attachment scheme, etc.). Embodiments may use such an existing cavity as a particle trap cavity 364 by forming a canal 362 connecting the cavity to the actuator region 352.

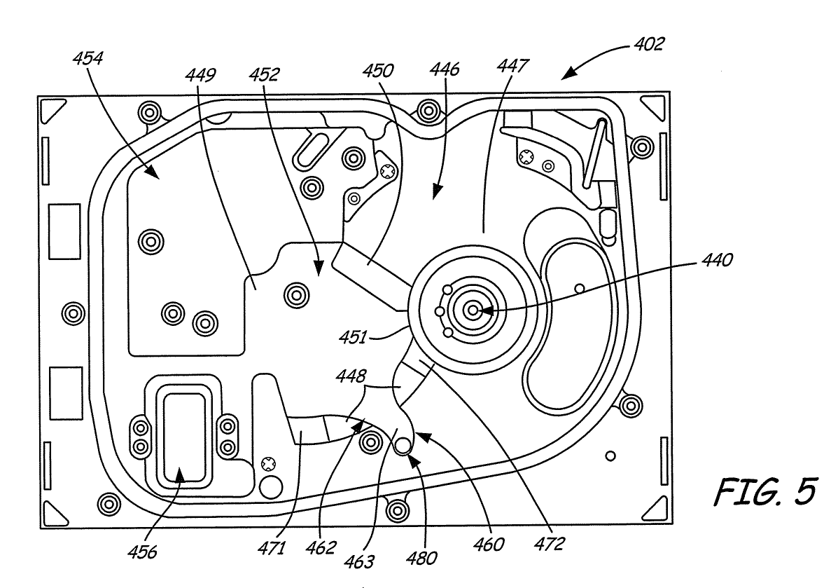

FIG. 5 is a top view of a hard disc drive base 402 that has a particle diverter 460 with a particle trap hole 480. Like base 202 illustrated in FIG. 2 and base 302 illustrated in FIG. 3, base 402 includes features for accommodating various internal components of a disc drive. Some of these features include: a motor well 440 that has an actuator region transition portion 451; a medium region 446 that has a planar surface 447, a leading surface 448 that has a first portion 471 and a second portion 472; a trailing surface 450; an actuator region 452 that has a planar surface 449 which is recessed below medium region planar surface 447; a voice coil motor region 454; and an electronic circuit region 456. In one embodiment, any or all of leading surface 448, trailing surface 450, and motor well transition portion 451 are sloped from the lower recessed planar surface 449 to the higher elevated medium region planar surface 447.

Base 402 also includes a particle diverter 460. Diverter 460 includes a canal 462 and a particle trap hole 480. Canal 462 has a bottom surface 463 that, in one embodiment, is coplanar with actuator planar surface 449. Canal 462 is defined in part by a portion of actuator region 452, leading surface 448, medium region 446, and the entrance to hole 480. In another embodiment, canal 462 is defined in part by a portion of the trailing surface 450 instead of a portion of the leading surface 448. In one embodiment, a canal opening is formed by the trailing surface comprising two portions and the canal extends from the trailing surface away from actuator region.

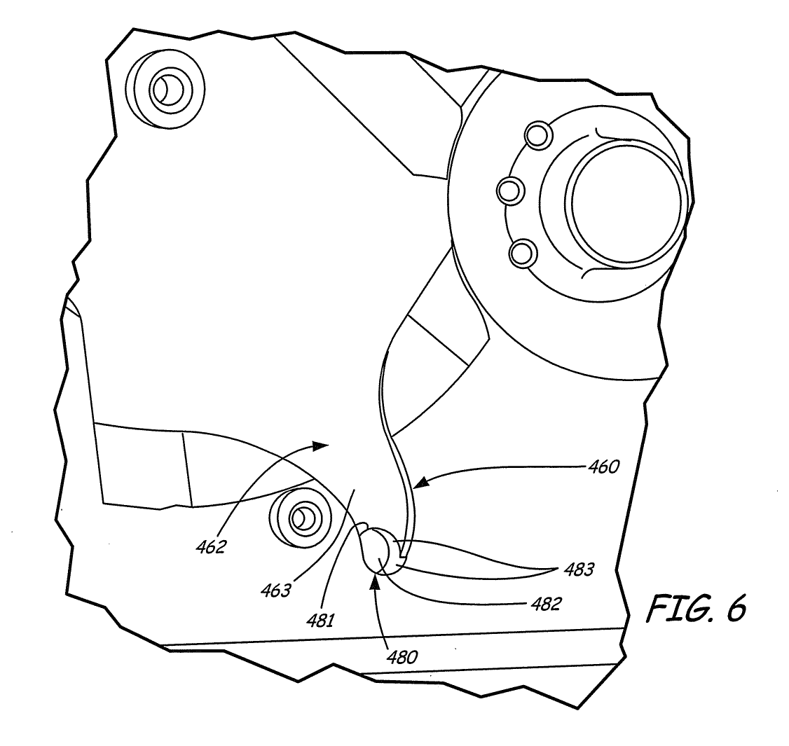

FIG. 6 is an enlarged top perspective view of particle diverter 460 with particle trap hole 480. Hole 480 has an opening 481 that is in fluid communication with particle diverter canal 462. Hole 480 also has a bottom surface 482 and surrounding walls 483. In one embodiment, bottom surface 482 is below canal bottom surface 463 (i.e., further recessed). In one embodiment, particle diverter canal 462 and hole 480 are integrally formed with base 402, for example, by metal injection molding, stamping, machining, or other types of processes. In one embodiment, particle diverter 460 utilizes existing base 402 features. For example, base 402 may have an existing through hole that serves an existing function (e.g., enables automated machine handling during assembly, etc.). In some embodiments, this existing through hole is sealed and used as a particle trap hole 480.

Particle diverters such as diverter 360 illustrated in FIGS. 3 and 4, and diverter 460 illustrated in FIGS. 5 and 6, reduce particle related disc drive failures. One cause of particle related failures comes from high velocity ballistic impacts. For example, particles in a disc drive enter the actuator region (e.g. region 352 in FIG. 3) and are projected at the recording media (e.g. disc 107 in FIG. 1) by a surface such as a leading surface (e.g. surface 348 in FIG. 3), a trailing surface (e.g. surface 350 in FIG. 3), or a motor well transition surface (e.g. portion 351 in FIG. 3). When particles impact the recording media in these situations, the recording media is damaged and the disc drive fails to function properly (e.g. data recorded to the damaged disc area cannot be retrieved). These types of high velocity ballistic impacts become more frequent and problematic as disc drive media rotational speeds are increased. These impacts are also more problematic with media utilizing perpendicular storage as opposed to longitudinal storage. Perpendicular storage media store data at a higher density than longitudinal storage media. This means that for a given size of a damaged disc area, more data will be lost in a perpendicular storage media than in a longitudinal storage media. Diverters such as 360 and 460 reduce these types, as well as other types, of high velocity impacts.

Particles from any number of sources can enter the actuator region of a hard disc drive. For example, some particles may be in the disc drive that came from contaminated air in the assembly line, or some particles may be in the disc drive that were generated during disc drive operation such as deteriorating coverlay from a suspension assembly. These particles move throughout the disc drive and some come into the actuator region because of air flow, pressure differentials, physical momentum, or a variety of other causes. When particles enter the actuator region in a hard disc drive base with a particle diverter (e.g. base 302 in FIG. 3), particles move toward and enter the particle diverter canal (e.g. canal 362 in FIG. 3 and canal 462 in FIG. 4). This movement is again caused by air flow, pressure differentials, physical momentum, or any other factor leading to particle movement. The particle diverter provides an alternative path for particles entering the actuator region and the particles are directed away from, or diverted from, impacting the recording media. This particle diversion reduces harmful high velocity ballistic impacts and reduces disc drive reliability issues associated with those impacts.

Besides high velocity ballistic impacts, another cause of particle related disc drive failures comes from particles being deposited on the recording media. In these situations, the recording media is damaged when a recording head or slider (e.g. slider 110 in FIG. 1) collides with a deposited particle. Diverters such as 360 and 460 also reduce these types of failures. Similar to how the diverters prevent ballistic impacts, the diverters also divert particles from being deposited on disc drive media. Particles enter a canal (e.g. canal 362 in FIG. 3 or canal 462 in FIG. 4) and are diverted away from being deposited on a media surface.

In addition to particle diverter canals reducing disc drive particle related failures, particle diverter traps such as particle trap cavity 364 illustrated in FIGS. 3 and 4, and particle trap hole 480 illustrated in FIGS. 5 and 6, also reduce particle related failures. Particles enter a trap, for example from a diverter canal, and are prevented from returning to an area of the disc drive where they may collide with or be deposited on recording media. For example, particle diverter cavity bottom surface 366 and surrounding walls 367 prevent particles from escaping the cavity. Similarly, particle diverter hole bottom surface 482 and surrounding walls 483 prevent particles from escaping the hole. Embodiments of particle traps are recessed and contain the particles in the traps. Other embodiments of particle traps may not fully contain particles or be recessed but may at least restrict the movement of particles. Embodiments of traps prevent movement or escape of particles when the entire disc drive is physically moved.

It is worth noting that particle diverters do not need to include a particle trap. For example, embodiments of diverter 360 illustrated in FIG. 3 only include a particle diverter canal 362 and do not include a particle trap cavity 364. In these embodiments, disc drive particle related failures are still reduced by the canal feature diverting particles away from the recording media despite the diverter not having a trap. Obviously of course, some embodiments of diverters such as those shown in FIGS. 3-6 include both a canal feature and a trap feature, and utilize one or both of those features to reduce particle related failures.

It is to be understood that even though numerous characteristics and advantages of various embodiments of the disclosure have been set forth in the foregoing description, this disclosure is illustrative only, and changes may be made in detail, especially in matters of structure and arrangement of parts within the principles of the disclosure to the full extent indicated by the broad general meaning of the terms in which the appended claims are expressed. In addition, although the embodiments described herein are directed to hard disc drive particle diverters, it will be appreciated by those skilled in the art that the teachings of the disclosure can be applied to other types of data storage systems, without departing from the scope and spirit of the disclosure.

What is claimed is:

1. A base for a data storage system comprising:
an actuator region; and
a particle diverter with a particle diverter opening adjacent to the actuator region.

2. The base of claim 1 wherein the particle diverter comprises a canal.

3. The base of claim 2 wherein the canal begins at the particle diverter opening and extends away from the actuator region.

4. The base of claim 2 wherein the particle diverter further comprises a particle trap.

5. The base of claim 4 wherein the particle trap is a particle trap cavity.

6. The base of claim 4 wherein the particle trap is a particle trap hole.

7. The base of claim 4 wherein the actuator region and the particle diverter are in fluid communication with one another.

8. The base of claim 1 wherein the particle diverter has a surface that is coplanar with an actuator region surface.

9. A base for a data storage system comprising:
an actuator region;
a sloped surface adjacent to the actuator region, the sloped surface having a first sloped portion and a second sloped portion; and
a particle diverter with an opening, wherein the opening is between the sloped surface's first and second sloped portions.

10. The base of claim 9 wherein the particle diverter comprises a canal and a particle trap.

11. The base of claim 9 wherein the particle diverter has a surface that is coplanar with an actuator region surface.

12. The base of claim 9 wherein the sloped surface is a leading surface.

13. The base of claim 9 wherein the sloped surface is a trailing surface.

14. The base of claim 9 wherein the data storage system is a hard disc drive.

15. A base for a data storage system comprising:
an actuator region; and
a particle diverter canal, wherein the particle diverter canal and the actuator region are formed in part by a common surface.

16. The base of claim 15 further comprising a particle trap.

17. The base of claim 16 wherein the particle trap has a surface that is below the common surface.

18. The base of claim 16 wherein the particle trap is formed in part by a sealed through hole.

19. The base of claim 15 wherein the common surface forms the bottom surface of the actuator region.

20. The base of claim 15 wherein the common surface forms the bottom surface of the particle diverter canal.
